(19) United States
(12) Patent Application Publication
(10) Pub. No.: US 2006/0285835 A1
(43) Pub. Date: Dec. 21, 2006

(54) LABEL SURFACE PRINTING METHOD OF AN OPTICAL DISC MEDIA, OPTICAL DISC RECORDER AND METHOD OF CREATING PROGRAM GUIDE INFORMATION

(76) Inventors: Takashi SUZUKI, Fuchu-shi (JP); Hideki Otsuka, Mishima-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/423,788

(22) Filed: Jun. 13, 2006

(30) Foreign Application Priority Data
Jun. 20, 2005 (JP) 2005-179302

(51) Int. Cl. H04N 5/00

(52) U.S. Cl. 386/126

(57) ABSTRACT

There is disclosed a method of printing data on a label surface of an optical disc media, comprising acquiring program guide information including address information for downloading program information including title and print data printable on a label surface of an optical disc media from a network, displaying broadcast program guide on a monitor based on the program guide information, downloading print data corresponding to a broadcast program selected from the broadcast program guide based on the address information, and printing the downloaded print data on the label surface of the optical disc media.

### CROSS-REFERENCE TO RELATED APPLICATIONS

This application is based upon and claims the benefit of priority from prior Japanese Patent Application No. 2005-179302, filed Jun. 20, 2005, the entire contents of which are incorporated herein by reference.

### BACKGROUND OF THE INVENTION

1. Field of the Invention

The present invention relates to a method of creating program guide information used for television broadcast program reservation, and to an optical disc recording method using program guide information. Moreover, the present invention relates to an optical disc recorder.

2. Description of the Related Art

An optical disc recorder recording broadcasted broadcast program to an optical disc has come into wide use. In order to manage the optical disc to which a broadcast program is written, information such as title of the broadcast program needs to be written to the label surface of an optical disc media.

The following methods are employed to write the foregoing information such as title to the label surface of the optical disc media. One is handwriting, and another is a method of using a printer with optical disc media print function.

User needs to have a personal computer to print information such as title using the printer. If user has no personal computer, user can not help writing information by handwriting. However, there is a problem that handwriting is not beautiful visually.

In the meanwhile, the following technique has been proposed (see US Patent Publication No. A 2003/0108708). According to the technique, special treatment is subjected to the label surface of the optical disc media, and print is made with respect to the label surface using a pickup laser of an optical disc drive. For example, an optical disc recorder is equipped with the optical disc drive capable of printing data to the label surface. By doing so, data is printed to the label surface of the optical disc media even if user has no personal computer and printer.

However, the optical disc recorder capable of printing data to the label surface of the optical disc media is the process of product development stage. It is not obvious how to prepare data printed to the label surface of the optical disc media for user.

The optical disc recorder has no keyboard; for this reason, test is hard to be inputted, and it is troublesome for user to prepare print data. Therefore, it is desired to provide method and apparatus for readily acquiring data printed to the label surface of the optical disc media by user.

### BRIEF SUMMARY OF THE INVENTION

An object of the present invention is to provide a label surface printing method of an optical disc media, which can provide data printed to the label surface of the optical disc media to user, and can readily print the data acquired by user to there. Moreover, another object of the present invention is to provide an optical disc recorder. Still another object of the present invention is to provide a method of creating program guide information.

According to one aspect of the present invention, there is provided a method of printing data on a label surface of an optical disc media, comprising:

acquiring program guide information including address information for downloading program information including title and print data printable on a label surface of an optical disc media from a network;

displaying broadcast program guide on a monitor based on the program guide information;

downloading print data corresponding to a broadcast program selected from the broadcast program guide based on the address information; and

printing the downloaded print data on the label surface of the optical disc media.

### BRIEF DESCRIPTION OF THE SEVERAL VIEWS OF THE DRAWING

FIG. 1 is a view showing the system of a broadcast station for broadcasting a digital broadcast programs according to one embodiment of the present invention;

FIG. 2 is a view showing the reception system of a receiver and the system for providing services relevant to the reception system according to one embodiment of the present invention;

FIG. 3 is a block diagram showing the configuration of a hard disc built-in optical disc recorder according to one embodiment of the present invention;

FIG. 4 is a flowchart to explain the procedure of downloading print data on a label surface of an optical disc media when making broadcast program reservation using EPG according to one embodiment of the present invention;

FIG. 5 is a view showing an EPG screen displayed on television;

FIG. 6 is a view showing a state reservation is made using a pointer;

FIG. 7 is a view showing a window for confirming reservation;

FIG. 8 is a view showing a window for confirming whether or not user downloads print data;

FIG. 9 is a view showing a window used when user selects a (thumbnail) image to be downloaded;

FIG. 10 is a view showing a window for confirming whether or not print data corresponding to the selected thumbnail image is downloaded;

FIG. 11 is a view showing a window for informing user of the progress of print data download;

FIG. 12 is a flowchart to explain the procedure of saving recording data recorded to a hard disc drive in an optical disc drive;

FIG. 13 is a flowchart following FIG. 12 to explain the procedure of saving recording data recorded to a hard disc drive in an optical disc drive;

FIG. 14 a view showing a window for displaying print data saved in a hard disc drive, and for confirming whether or not print may be made on a label surface of an optical disc media using the saved print data;

FIG. 15 is a view showing a window displaying a message for recommending user to turn over the optical disc media;

FIG. 16 a view showing a window for informing user of the progress of printing;

FIG. 17 is a view showing a window for confirming whether or not user desires to download print data;

FIG. 18 is a view showing a window for selecting a download image by user;

FIG. 19 is a view showing a window for confirming whether or not the selected image may be downloaded;

FIG. 20 is a view showing a window for informing user of the progress of print data download;

FIG. 21 is a flowchart to explain the procedure of printing data on the label surface of the optical disc media without making print in recording data write to the optical disc media;

FIG. 22 is a flowchart following FIG. 21 to explain the procedure of printing data on the label surface of the optical disc media without making print in recording data write to the optical disc media;

FIG. 23 is a view showing an EPG screen;

FIG. 24 is a view showing a state of selecting download program using a pointer;

FIG. 25 is a view showing a window for selecting a download image by user;

FIG. 26 is a view showing a window for confirming whether or not print data corresponding the selected thumbnail image may be downloaded;

FIG. 27 is a view showing a window for informing user of the progress of print data download;

FIG. 28 is a view showing a window for confirming whether or not print may be made using the downloaded image;

FIG. 29 is a view showing a window displaying a message for recommending user to turn over the optical disc media;

FIG. 30 is a view showing a window for informing user of the progress of print; and

FIG. 31 is a flowchart to explain the procedure of creating EPG data.

### DETAILED DESCRIPTION OF THE INVENTION

Embodiments of the present invention will be described below with reference to the accompanying drawings.

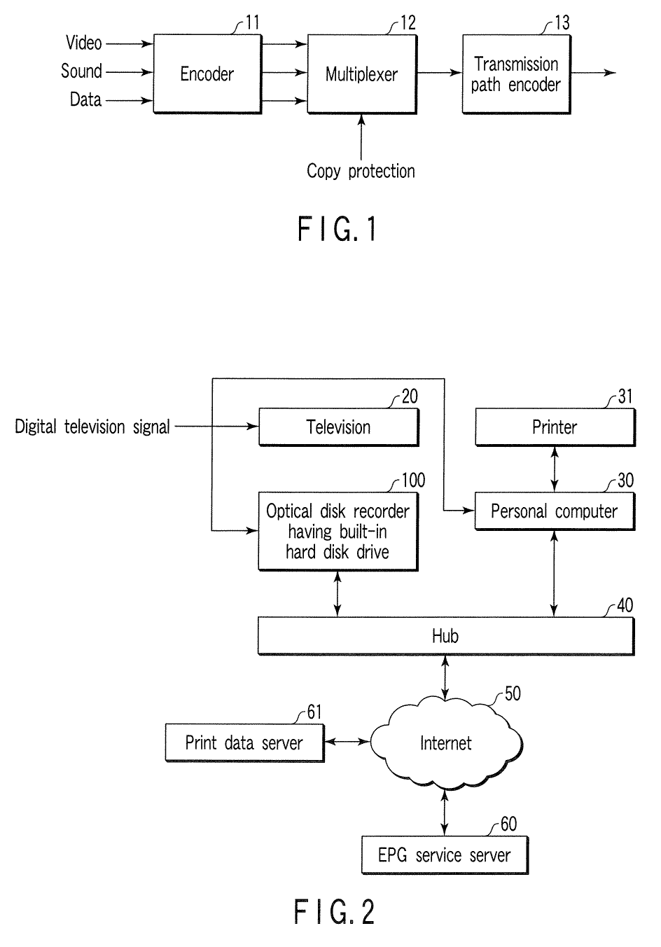

FIG. 1 is a view showing the system of a broadcast station for broadcasting digital broadcast programs according to one embodiment of the present invention.

Video, sound and data are encoded via an encoder 11. The encoded various signals are multiplexed into one digital data via a multiplexer 12. In this case, the multiplexer 12 multiplexes a copyright protection signal for protecting information copyright. The multiplexed digital data is encoded to each format suited to digital satellite broadcast, terrestrial digital broadcasting and various transmission lines such as CATV via a transmission line encoder 13. The digital signal encoded by the transmission line encoder 13 is transmitted as a digital broadcasting signal.

FIG. 2 is a view showing the reception system on a receiver and the system for providing services relevant to the reception system.

The transmitted digital broadcasting signal is received via an antenna of each home. Thereafter, the digital broadcasting signal is sent to a hard disc built-in optical disc recorder 100, which has rapidly come into wide use in recent years, in addition to a television 20. Moreover, a personal computer 30 having a built-in tuner is capable of receiving the foregoing digital broadcasting signal. The optical disc recorder 100 having a built-in hard disc and the personal computer 30 are connected to an Internet line 50 via a hub 40. The optical disc recorder 100 having a built-in hard disc downloads broadcast program information (hereinafter, referred to as EPG information) from an EPG (electronic program guide) service server 60 via the Internet line 50. In the present embodiment, the Internet line 50 is connected with a print data server 61. The print data server 61 stores print data on a label surface of an optical disc. The print data server 61 may be identical to the EPG service server 60.

In the present embodiment, the following example is given. Specifically, the EPG information provided via the Internet line 50 is displayed on the television 20. Then, the hard disc built-in optical disc recorder 100, that is, hard disc drive 110 captures optical disc label surface print information from the program information to achieve print.

A printer 31 connected to the personal computer is capable of printing data on a label surface of an optical disc media according existing print technique.

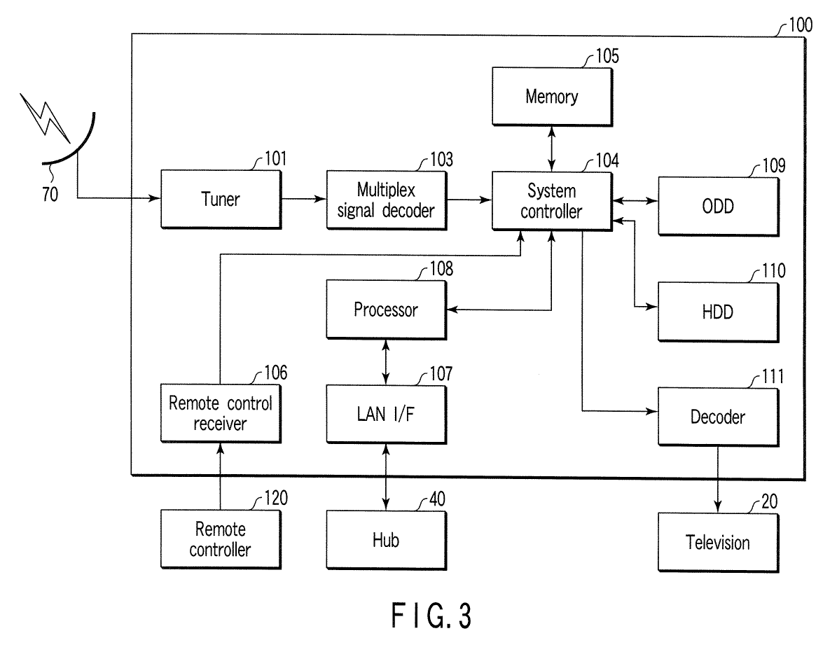

The internal configuration of the hard disc built-in optical disc recorder 100 a will be explained below with reference to FIG. 3.

A digital broadcast signal received by an antenna 70 is inputted to a tuner 101. An output from the tuner 101 is supplied to a multiplex signal decoder 103 decoding a received multiplex signal. The multiplex signal decoder 103 supplies the decoded video/sound data to a system controller 104. The system controller 104 takes various procedures in accordance with external instructions from a remote controller 120 via a remote control receiver 106. The system controller 104 controls information write and read to a memory 105 while making a video signal data exchange with optical disc drive (ODD) 109, hard disc drive (HDD) 110 and decoder 111.

For example, video/sound data supplied to the system controller 104 is recorded to an optical disc media using the optical disc drive 109. In this case, the video/sound data is supplied to the optical disc drive 109 from the system controller 104 to record information in an optical disc medium. Conversely, information recorded in the optical disc medium is supplied from the optical disc drive 109 to the system controller 104.

Moreover, the video signal data supplied to the system controller 104 is recorded to the hard disc drive 110. In this case, the video/sound data is supplied from the system controller 104 to the hard disc drive 110 to record information in the hard disc drive 110. Simultaneously, information recorded in the hard disc drive 110 is supplied to the system controller 104.

The video/sound data to the decoder 111 from the system controller 104 is decoded and outputted to be displayable on the television 20.

The hard disc built-in optical disc recorder 100 is connectable with the Internet line 50 and the personal computer 30. Information from the foregoing Internet and personal computer is supplied to the system controller 104 after the following processing is carried out. Specifically, information from a LAN interface (LAN I/F) 107 is converted into data process-able by the system controller via a processor 108. Information supplied via the Internet line 50 includes EPG information containing address information for downloading printing data printable on an optical disc label surface.

A label surface of a dedicated optical disc media is downward placed on a tray, and thereby, the optical disc drive 109 prints data on when the label surface. In this case, the label surface is subjected to special treatment reacting with pickup laser.

[1. Reservation Procedure]

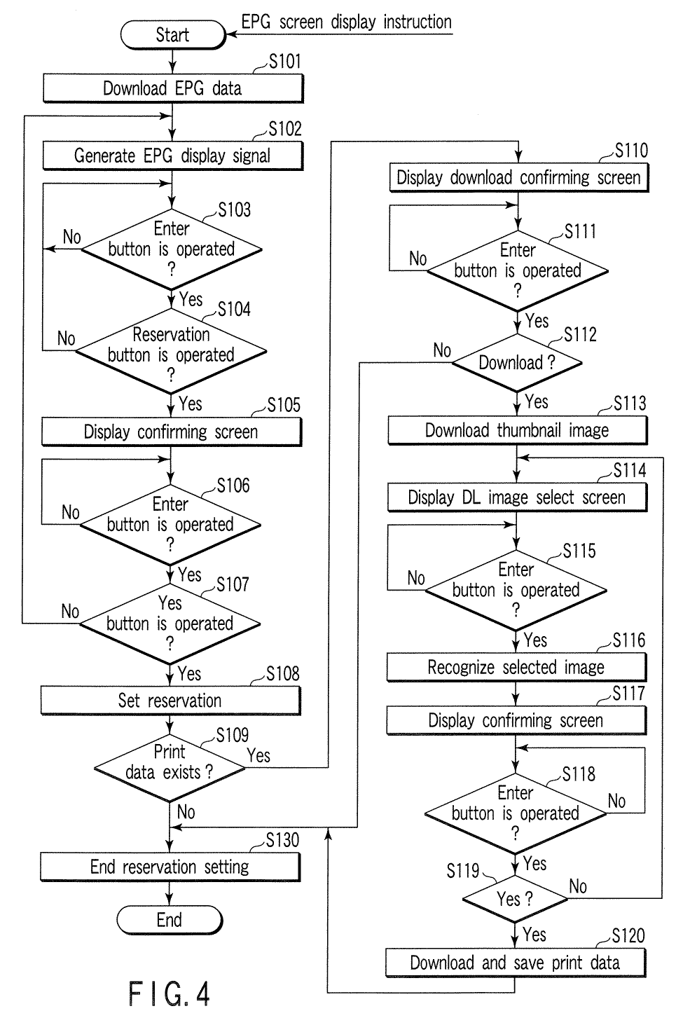

The procedure of downloading print data will be explained below with reference to FIG. 4. The print data is used for printing data on the label surface print to the optical disc media when making recording reservation of broadcast programs using EPG information.

First, user instructs the remote control receiver 106 of the hard disc built-in optical disc recorder 100 to display an EPG screen, using the remote controller 120. The system controller 104 instructs the processor 108 to carry out the following processing. Namely, the processor 108 downloads EPG data, and converts it into process-able data, and thereafter, supplies it to the system controller 104. According to the instruction from the system controller 104, the processor 108 downloads EPG information from the EPG server 60 via the Internet line 50 (step S101). When downloading the EPG information, the processor 108 converts EPG data process-able by the system controller 104, and thereafter, supplies the converted EPG data to the system controller 104.

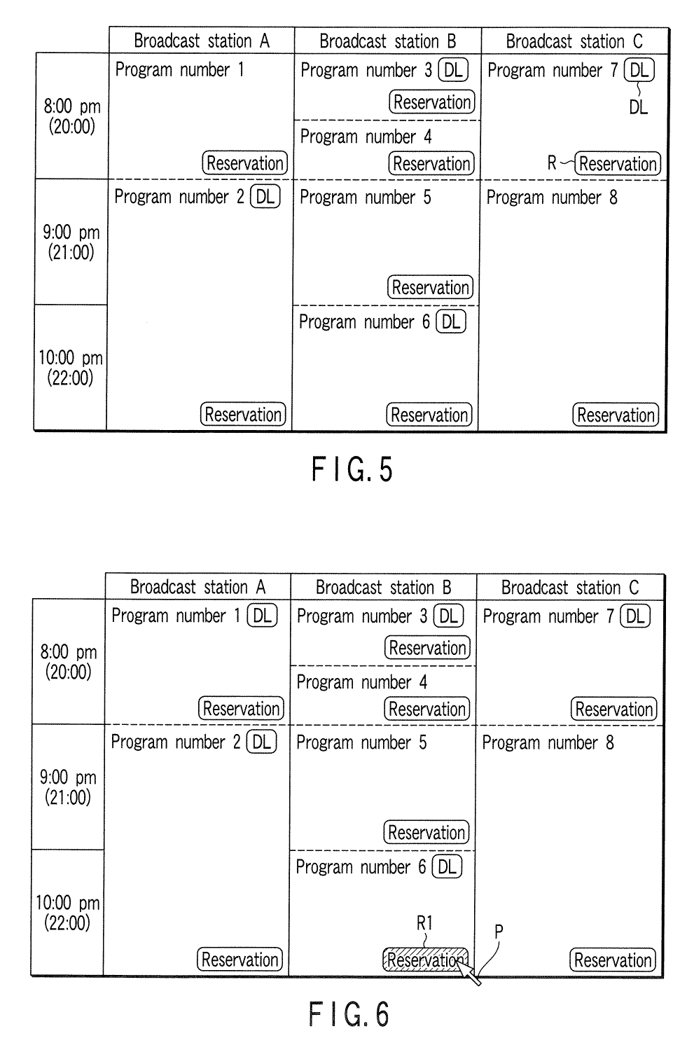

The system controller 104 generates an EPG display signal used for display on the television 20 using the supplied EPG data (step S102). The generated EPG display signal is supplied to the television 20, and then, an EPG screen shown in FIG. 5 is displayed on there. In this case, the EPG display signal is supplied to the television 20 through the decoder 111. As seen from FIG. 5 and FIG. 6, the EPG screen is provided with reservation buttons R arranged in a program table. User operates the remote controller 120, and thereby, a pointer P moves in the screen. User operates the remote controller 120 to move the pointer P on the reservation button R, and presses an Enter (OK) button arranged on the remote controller 120, and thereby, the reservation procedure starts. Moreover, the EPG screen is provided with a download icon DL as depicted in FIG. 5. The download icon DL implies that print data for printing data on the label surface of an optical disc media is downloadable. As described later, if user reserves a print data downloadable program, a process of selecting whether or not user takes the download procedure is automatically provided.

The system controller 104 is waiting until user presses the Enter button of the remote controller 120 (step S103). In the standby time, the system controller 104 recognizes the position of the pointer P. When user presses the Enter button, the remote controller 120 issues an Enter button operation signal. When receiving the Enter button operation signal, the remote control receiver 106 gives interrupt notification that the Enter button is operated, to the system controller 104 (Yes in step S103).

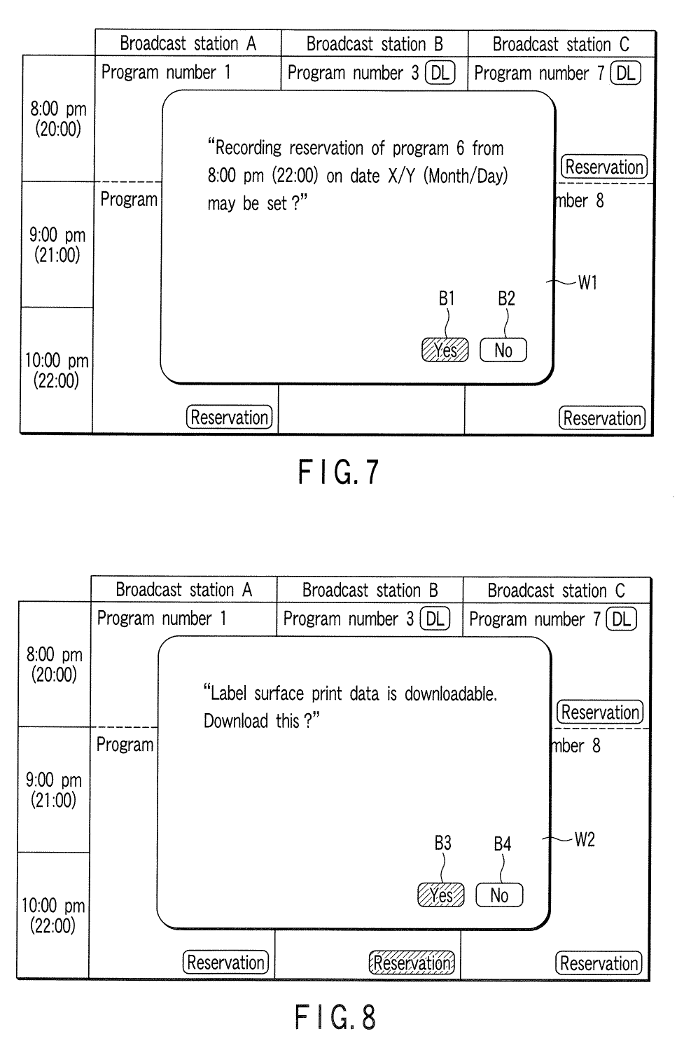

The system controller 104 determines the position of the pointer P on the EPG screen when the interrupt notification is given. As a result, if the pointer P is not positioned on the reservation button R, the system controller is waiting (No in step S104). On the other hand, the Enter button of the remote controller 120 is pressed in a state that the pointer P is positioned on the reservation button R (Yes in step S104). In this case, the system controller 104 displays a window for confirming whether or not a program reservation is made. For example, the Enter button of the remote controller 120 is pressed in a state that the pointer P is positioned on a reservation button R1 of a program 6, as shown in FIG. 6. In this case, the system controller 104 displays a window W1 for confirming whether or not the program corresponding to the reservation button R1 may be reserved on the EPG screen, as shown in FIG. 7. In the window W1, a message “Recording reservation of program 6 from 8:00 (22:00) pm on date X/Y (Month/Day) may be set?” is displayed. Simultaneously, Yes button B1 and No button B2 are arranged therein. User moves a cursor button of the remote controller 120 to select any of Yes button B1 and No button B2. Then, user presses the Enter button of the remote controller 120, and thereby, the procedure corresponding to the selected button is taken.

The system controller 104 is waiting until user presses the Enter button of the remote controller 120 (step S106). When user presses the Enter button, the remote controller 120 issues an Enter button operation signal. When receiving the Enter button operation signal, the remote control receiver 106 gives interrupt notification that the Enter button is operated, to the system controller 104 (Yes in step S106). The system controller 104 determines which of Yes button B1 and No button B2 on the EPG screen is selected using the Enter button of the remote controller 120. If No button B2 is selected (No in step S107), the system controller 104 closes the window W1 to display the initial EPG screen (step S102).

On the other hand, if Yes button B1 is selected (Yes in step S107), the system controller 104 instructs the memory 105 to store reservation setting of the program 6. By doing so, recording reservation setting of the program 6 is made (step S108). The foregoing recording reservation setting includes all thumbnail image data address and all print data address.

[1.1 Procedure of Downloading Print Data]

The system controller 104 confirms whether or not print data on the label surface of the optical disc media is downloadable referring to EPG data. If the print data is not downloadable (No in step S109), the system controller 104 ends reservation setting (step S130).

If the print data is downloadable (Yes in step S109), the system controller 104 displays a window W2 for confirming whether or not user desires to download print data in the EPG screen as shown in FIG. 8 (step S110). In the window W2, a message “Label surface print data is downloadable. Download this?” is displayed, and Yes button B3 and No button B4 are arranged. User operates a cursor button of the remote controller 120 to select any of Yes button B3 and No button B4. Then, user presses the Enter button of the remote controller 120, and thereby, the procedure corresponding to the selected button is taken.

The system controller 104 is waiting until user presses the Enter button of the remote controller 120 (step S111). When user presses the Enter button, the remote controller 120 issues an Enter button operation signal. When receiving the Enter button operation signal, the remote control receiver 106 gives interrupt notification that the Enter button is operated, to the system controller 104 (Yes in step S111). The system controller 104 determines which of Yes button B1 and No button B2 on the EPG screen is selected using the Enter button of the remote controller 120. If No button B4 is selected (No in step S112), the system controller 104 ends the reservation setting (step S130).

On the other hand, if Yes button B3 is selected (Yes in step S112), the system controller 104 instructs the processor 108 to download print data thumbnail images from the print server 61. By doing so, the processor 108 downloads all of thumbnail images (step S113). The thumbnail images data address is embedded in EPG data.

In this case, downloaded print data has an image file format such as BMP and JPEG. Even if the content is text information only, it is converted into an image file, and thereafter, provided as print data.

EPG information provided from the current broadcast signal has a limitation in the amount of multiplexing information. According to the foregoing EPG information via the Internet line 50, a great many of data is transferable. Thus, the present invention handles image files as label print data; therefore, it is really effective to use the EPG information provided via the Internet line 50. Simultaneously, it is possible to increase the kind of picture patterns of distributable optical disc label print data. This serves to broaden user's optional choice.

However, address information for downloading program information including title and print data via Internet line 50 is set to be included in receivable EPG information overlapped with broadcast signals from broadcast network. For this reason, the print data requires an amount of much information. Thus, the print data may be required from a server connected to the Internet line 50 using the foregoing address information. Moreover, the print data for label print is obtained in the following manner. Specifically, the print data address information is recorded to an optical disc as one of associated data appended to moving image data of a broadcast program together with the moving image data. By doing so, even if recording is made using an optical disc recorder, which is not connectable to Internet line 50, the optical disc is read using other optical disc recorder and personal computer connectable to Internet line 50. In the manner as described above, the print data is obtained using address information acquired in recording reservation.

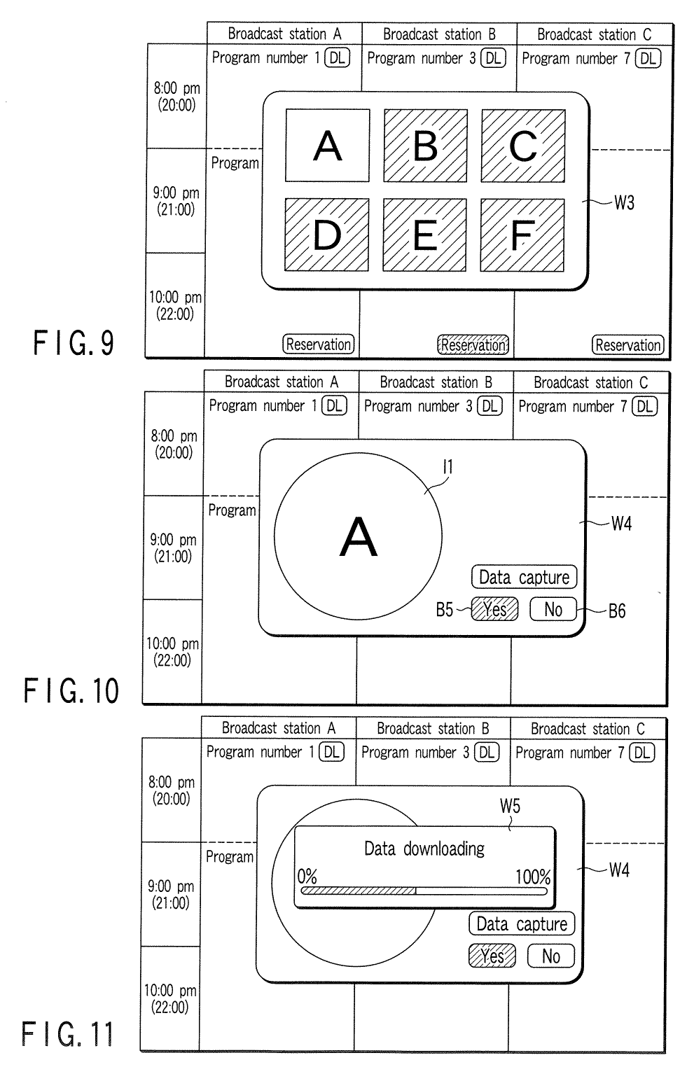

When all thumbnail image data are downloaded, the system controller 104 displays a window W3 for selecting a downloading image by user in the EPG screen, as shown in FIG. 9 (step S114). As seen from FIG. 9, thumbnail images A to F are displayed in the window W3. User operates the remote controller 120 to select any of the thumbnail images A to F thus displayed. The selected thumbnail image is displayed in a state of being highlighted; on the other hand, non-selected thumbnail images are displayed in a state of being darkened.

The system controller 104 is waiting until user presses the Enter button of the remote controller 120 (step S115). When user presses the Enter button, the remote controller 120 issues an Enter button operation signal. When receiving the Enter button operation signal, the remote control receiver 106 gives interrupt notification that the Enter button is operated, to the system controller 104 (Yes in step S115).

When receiving the interrupt notification, the system controller 104 determines the selected thumbnail image (step S116). As shown in FIG. 10, the system controller 104 displays a window W4 for confirming whether or not print data corresponding to the determined thumbnail image may be downloaded, in the EPG screen (step S117). In the window W4, a print image 11 obtained by enlarging and editing the thumbnail image, Yes button B5 and No button B6 are displayed (arranged). User operates the cursor button of the remote controller 120 to select any of Yes button B5 and No button B6. Then, when user presses the Enter button of the remote controller 120, the procedure corresponding to the selected button is taken.

The system controller 104 is waiting until user presses the Enter button of the remote controller 120 (step S118). When user presses the Enter button, the remote controller 120 issues an Enter button operation signal. When receiving the Enter button operation signal, the remote control receiver 106 gives interrupt notification that the Enter button is operated, to the system controller 104 (Yes in step S118). The system controller 104 determines which of Yes button B5 and No button B6 is selected using the Enter button of the remote controller 120. If No button B6 is selected (No in step S119), the system controller 104 again displays the window W3 for selecting a downloading image by user in the EPG screen (step S114).

On the other hand, if Yes button B5 is selected (Yes in step S119), the system controller 104 instructs the processor 108 to download print data thumbnail images from the print server 61. By doing so, the processor 108 downloads all of thumbnail images (step S113). When downloading print data, the system controller 104 displays a window W5 for informing user of the progress of print data downloading in the EPG screen. Print data address is embedded in EPG data. Then, when the print data is downloaded, the system controller 104 stores the print data in the hard disc drive 110 (step S120). In saving, information that print data is already downloaded may be added to reservation setting stored in the memory 105 in step S108. When print data saving ends, the system controller 104 ends the reservation setting procedure (step S130).

As described above, the reservation setting procedure is taken, and thereby, if the print data is downloadable, information that print data is downloaded is given to user. Thus, the print data is downloaded if user desires to download it. However, if user desires to download the print data later, address for downloading the print data is indefinite; for this reason, time is taken to download print data. On the contrary, print data is downloaded in reservation setting as described in the present embodiment. By doing so, user can reduce troublesome labor as compared with the case of downloading the print data later. Moreover, the print data is set to include all thumbnail image data address embedded in EPG data in reservation setting and all print data address. By doing so, address is registered in a database file prepared after recording, and thereby, it is possible to readily download print data later.

[2. Recording Procedure]

The recording operation of the optical disc recorder will be explained below. Although, recording data may be recorded to an optical disc media by the optical disc drive 109 in recording reservation, it is usually saved in the hard disc drive 110 in many cases. If the recording data is saved in the hard disc drive 110, recording date and title are registered in a database file of the hard disc drive 110. If print data is downloaded and saved in reservation, information that print data is saved in the database file is registered in the database. If the existence of print data is registered in the database file, the following advantage is given. Specifically, if recording data saved in the hard disc drive 110 is saved in an optical disc media by the optical disc drive 109, the system controller 104 refers to the database file, thereby recognizing that print data is saved in the hard disc drive 110. Thus, this serves to recommend user to print the print data on the label surface of the optical disc media. If print data is downloadable, the print data is registered in a database file of all print data address included in reservation setting and all thumbnail image data address corresponding to the print data, regardless of download or non-download of print data. As described above, the print data is registered in the database file. By doing so, it is possible to readily print data in the case where user does not downloaded print, and the case where user desires to download print data different from downloaded print data.

[3. Procedure of Write to Optical Disc Media]

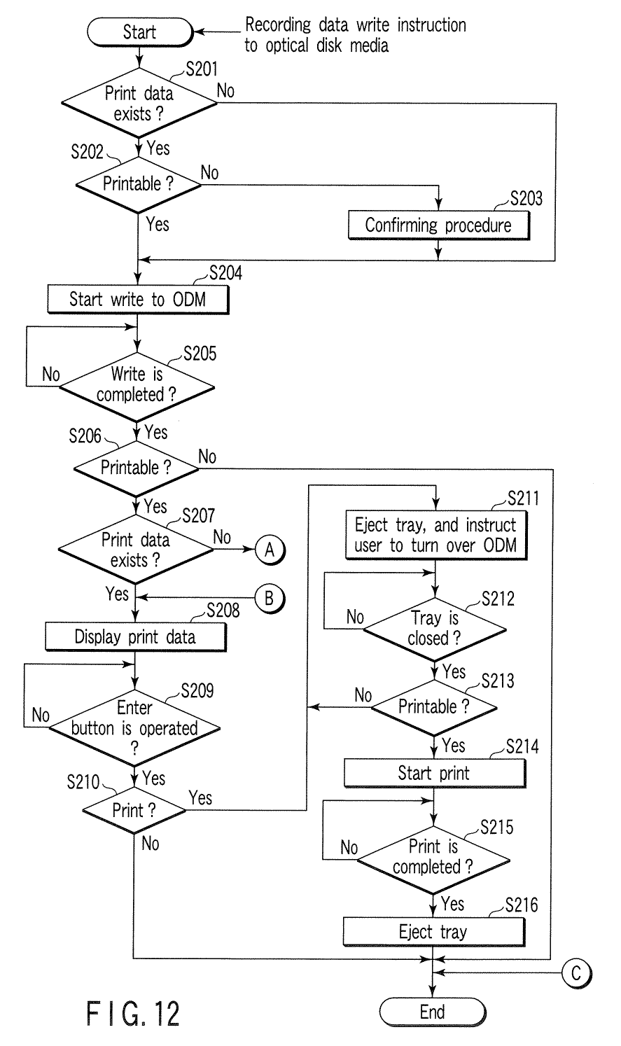

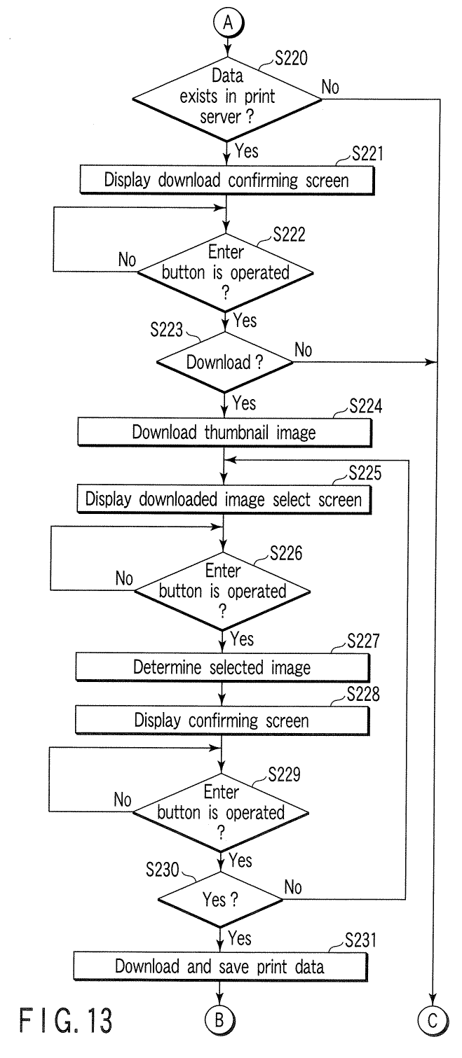

The procedure of saving recording data saved in the hard disc drive 110 in the optical disc drive 109 will be explained below with reference to FIG. 12 and FIG. 13. In the following procedure, recording reservation is made using EPG information, and print data and thumbnail image data address corresponding to the print data are registered in the database file.

User instructs the optical disc drive 109 to write recording data saved in the hard disc drive 110 of the hard disc built-in optical disc recorder 100 to an optical disc media. When write instruction is given, the system controller 104 determines whether or not the optical disc media is inserted in the optical disc drive 109. If the optical disc media is not inserted in the optical disc drive 109, a tray of the optical disc drive 109 is ejected, and then, the following message is displayed on a screen of the television 20. According the message, it is recommended user to place the optical disc media on the tray in a state that the label surface is upwardly set.

The system controller 104 refers to the database file of the hard disc drive 110 to confirm whether or not print data corresponding to recording data written to the optical disc media is saved in the hard disc drive 110 (step S201).

If print data is saved in the hard disc drive 110 (Yes in step S201), the system controller 104 reads information of the optical disc media inserted in the optical disc drive 109. Then, the controller 104 determines whether or not the label surface is printable by the optical disc drive 109 (step S202)

If the label surface of the optical disc media is printable (Yes in step S202), the system controller 104 starts the procedure writing recording data to an optical disc media (ODM) (step S204). If the recording data is protected, it is written to the optical disc media, and thereafter, recording data saved in the hard disc drive 110 is erased.

If the label surface of the optical disc media is not printable (No in step S202), the system controller 104 confirms user whether or not recoding data may be written to the optical disc media inserted in the optical disc drive 109 (step S203). If user selects to write recording data to the optical disc media inserted in the optical disc drive 109, the system controller 104 starts the procedure of writing recording data to the optical disc media (step S204). If user does not select to write recording data to the optical disc media inserted in the optical disc drive 109, the tray on which the optical disc media is placed is ejected. Then, an optical disc media printable by the optical disc drive 109 is inserted, and thereafter, the procedure of writing recording data to the optical disc media is taken (step S204).

[3.1 Print Procedure]

If data write is completed (Yes in step S205), the system controller 104 reads information of the optical disc media inserted in the optical disc drive 109. Then, the controller 104 determines whether or not the label surface is printable by the optical disc drive 109 (step S206). If the optical disc media inserted in the optical disc drive 109 is not a printable type (No in step S206), the system controller 104 ends the write procedure.

If the optical disc media inserted in the optical disc drive 109 is a printable type (Yes in step S206), the system controller 104 takes the following procedure. The controller 104 refers to the database file of the hard disc drive 110 to confirm whether or not print data corresponding to recording data written to the optical disc media is saved in the hard disc drive 110 (step S207).

[3.1.1 Print Procedure in the Case where Print Data is Saved]

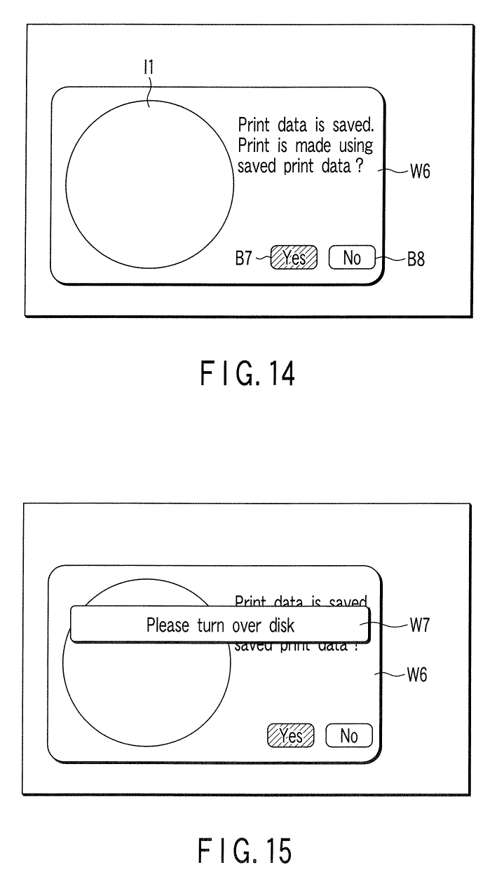

If print data is saved in the hard disc drive 110 (Yes in step S207), print data 11 saved in the hard disc drive 110 is displayed in a window W6, as shown in FIG. 14. In addition, Yes button B7 and No button B8 are displayed to confirm whether or not print may be made on the label surface of the optical disc media using the saved print data I1 (step S208). User operates the cursor button of the remote controller 120 to select any of Yes button B7 and No button B8. Then, user operates the Enter button of the remote controller 120, and thereby, the procedure corresponding to the selected button is taken.

The system controller 104 is waiting until user presses the Enter button of the remote controller 120 (step S209). When user presses the Enter button, the remote controller 120 issues an Enter button operation signal. When receiving the Enter button operation signal, the remote control receiver 106 gives interrupt notification that the Enter button is operated, to the system controller 104 (Yes in step S209). The system controller 104 determines which of Yes button B7 and No button B8 is selected using the Enter button of the remote controller 120. If No button B8 is selected (No in step S210), the system controller 104 ends the write procedure.

In this case, it may be confirmed whether or not other print data is downloadable from the print data server 61 without ending the write procedure. Thereafter, if downloadable, the controller 104 gives information that other print data exists to user, and then, confirms whether or not user desires to display the existing other print data. If user desires to display the existing other print data, thumbnail image data is downloaded from the print data server 61, and then, the downloaded thumbnail image is displayed. The system controller confirms user's intention whether image to be printed exists in the displayed thumbnail images.

If Yes button B7 is selected (Yes in step S210), the system controller 104 ejects the tray of the optical disc drive 109. Thereafter, the controller 104 displays a message window W7 for turning over the optical disc media by user on the television 20, as depicted in FIG. 15 (step S211).

The system controller 104 is waiting until the tray of the optical disc drive 109 is closed (step S212). If the tray of the optical disc drive 109 is closed, the optical disc drive 109 gives interrupt notification to the system controller 104 (Yes in step S212).

When the tray of the optical disc drive 109 is closed, the system controller 104 determines whether or not a laser radiating section of the optical disc drive 109 is set in a printable state opposite to the label surface of the optical disc media there (step S213). If the laser radiating section is not set in a printable state (No in step S213), the flow returns to the preceding step S211, and the tray is ejected to recommend user to turn over the optical disc media.

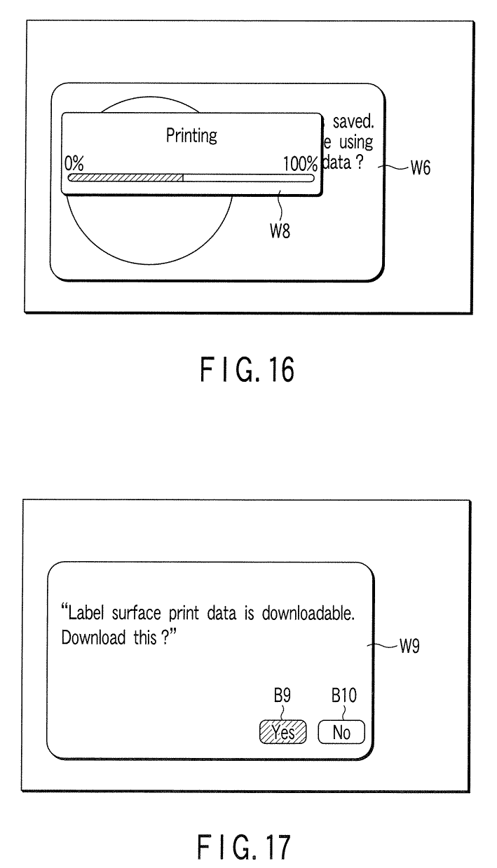

If the system controller 104 determines that the optical disc media is set in a printable state (Yes in step S213), the controller 104 executes the following procedure. Namely, the controller 104 starts the procedure of making print on the label surface of the optical disc media inserted in the optical disc drive 109 using print data saved in the hard disc drive 110 (step S214). During printing, the system controller 104 displays a window W8 for informing user of the progress of printing on a screen of the television 20, as shown in FIG. 16.

If print onto the label surface of the optical disc media is completed (Yes in step S215), the system controller 104 ejects the tray on which the optical disc media is placed (step S216). In this case, information that print onto the label surface may be completed is displayed on the television 20 in place of ejecting the tray.

[3.1.2 Print Procedure in the Case where Print Data is not Saved]

The following is an explanation about the case where it is determined in step S207 that print data is not saved in the hard disc drive 110 (No in step S207).

If print data is not saved in the hard disc drive 110 (No in step S207), the system controller 104 instructs the processor 108 to make an access to the print data server 61, and to confirm whether or not downloadable print data exists. The processor 108 makes an access to the print data server 61 to confirm whether or not downloadable print data exists. Then, the processor 108 informs the system controller 104 of the result.

If downloadable print data does not exist in the print data server 61 (No in step S220), the write procedure ends.

(Print Procedure in the Case where Print Data is not Downloaded in Reservation)

If print data is downloadable (Yes step S220), the system controller 104 displays a window W9 for confirming whether or not user desires to download print data on the EPG screen, as shown in FIG. 17 (step S221). In the window W9, a message “Label surface print data is downloadable. Download this?” is displayed. In addition, Yes button B9 and No button B10 are arranged therein. User operates the cursor button of the remote controller 120 to select any of Yes button B9 and No button B10. Then, user operates the Enter button of the remote controller 120, and thereby, the procedure corresponding to the selected button is taken.

The system controller 104 is waiting until user presses the Enter button of the remote controller 120 (step S222). When user presses the Enter button, the remote controller 120 issues an Enter button operation signal. When receiving the Enter button operation signal, the remote control receiver 106 gives interrupt notification that the Enter button is operated, to the system controller 104 (Yes in step S222). The system controller 104 determines which of Yes button B9 and No button B10 is selected using the Enter button of the remote controller 120. If No button B10 is selected (No in step S223), the system controller 104 ends the write procedure.

If Yes button B9 is selected (Yes in step S223), the system controller 104 instructs the processor 108 to download thumbnail image data of the print data from the print data server 61. The processor 108 downloads all thumbnail images (step S224). The address of the thumbnail image data is embedded in EPG data.

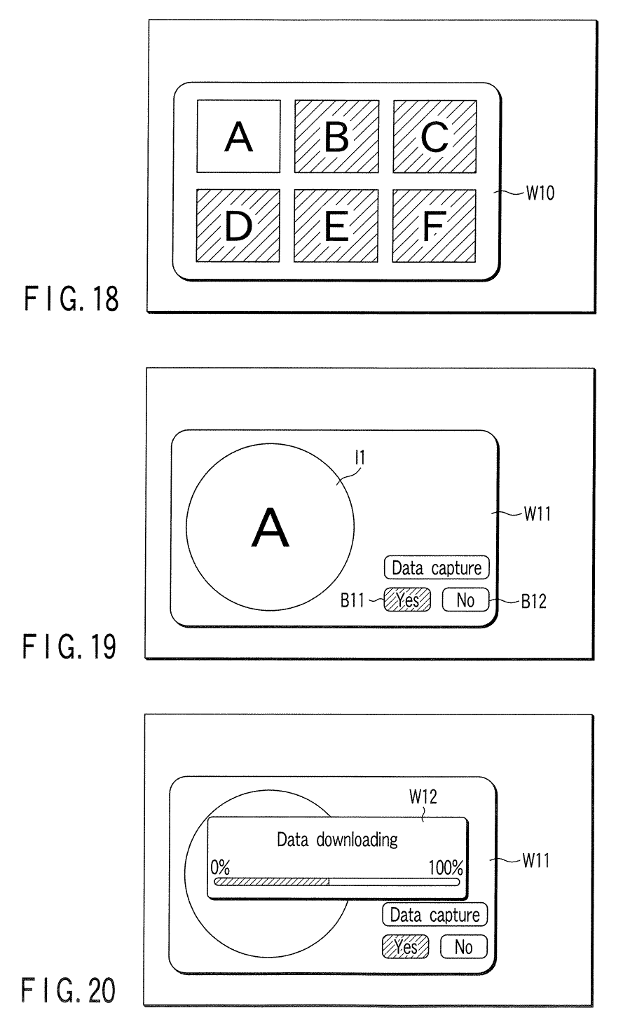

When all thumbnail image data are downloaded, the system controller 104 displays a select window W10 for selecting a download image by user in the EPG screen, as depicted in FIG. 18 (step S225). As seen from FIG. 18, thumbnail images A to F are displayed in the window W10. User operates the remote controller 120 to select any of the thumbnail images A to F thus displayed. The selected thumbnail image is displayed in a state of being highlighted; on the other hand, non-selected thumbnail images are displayed in a state of being darkened.

The system controller 104 is waiting until user presses the Enter button of the remote controller 120 (step S226). When user presses the Enter button, the remote controller 120 issues an Enter button operation signal. When receiving the Enter button operation signal, the remote control receiver 106 gives interrupt notification that the Enter button is operated, to the system controller 104 (Yes in step S226). The system controller 104 recognizes the selected thumbnail image (step S227). As depicted in FIG. 19, the system controller 104 displays a window W11 for confirming whether or not user desires to download the selected thumbnail image in the EPG screen (step S228). In the window W11, a print image I1 obtained by enlarging and editing the thumbnail image, Yes button B11 and No button B12 are displayed (arranged).

The system controller 104 is waiting until user presses the Enter button of the remote controller 120 (step S229). When user presses the Enter button, the remote controller 120 issues an Enter button operation signal. When receiving the Enter button operation signal, the remote control receiver 106 gives interrupt notification that the Enter button is operated, to the system controller 104 (Yes in step S229). The system controller 104 determines which of Yes button B11 and No button B12 is selected using the Enter button of the remote controller 120. If No button B12 is selected (No in step S230), the system controller 104 again displays the window W10 for selecting a download image by user in the EPG screen (step S225).

If Yes button B11 is selected (Yes in step S230), the system controller 104 instructs the processor 108 to download print data from the print data server 61. When downloading the print data, the system controller 104 displays a window W12 for informing user of the progress of print data downloading in the screen, as shown in FIG. 20. When the print data is downloaded, the system controller 104 stores the print data in the hard disc drive 110 (step S231).

After the print data is saved, the foregoing procedures described in steps S208 to S216 are taken, and thereby, the write procedure ends.

The procedures described above are taken, and thereby, recording data write and print to the optical disc media are achieved via a serial flow. Therefore, user can readily make print on the label surface of the optical disc media using the downloaded print data.

[4. Print Procedure in the Case where No Print Data Address is Given]

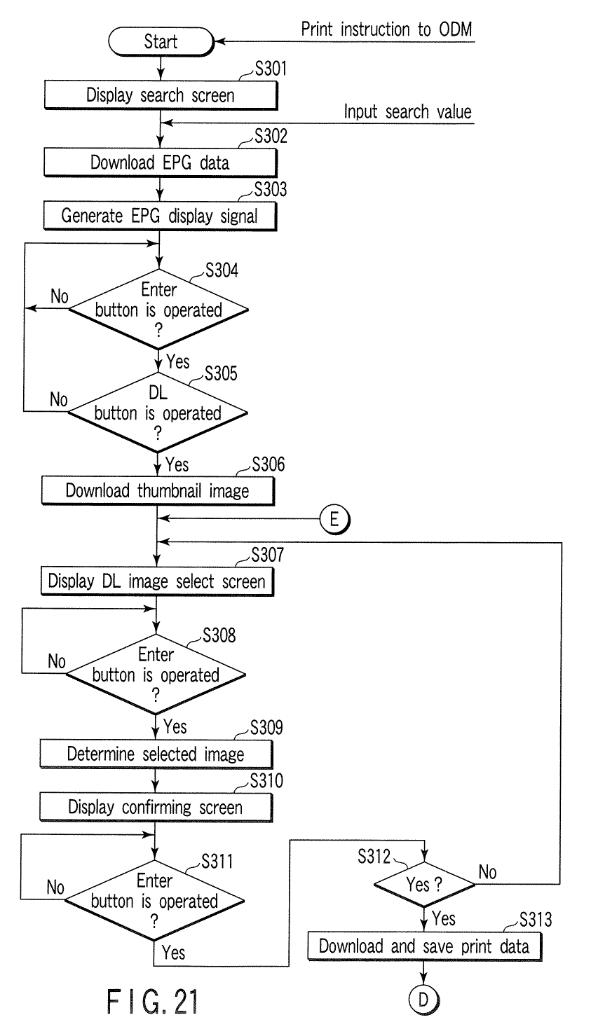

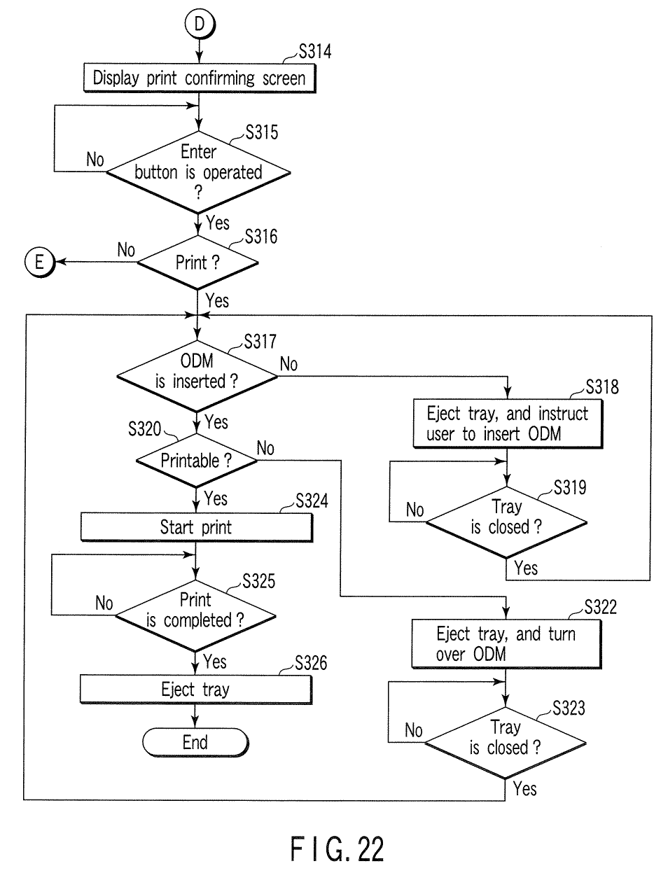

The procedure of making print on the label surface of the optical disc media without carrying out print in recording data write to there will be explained below with reference to FIG. 21 and FIG. 22.

User instructs to make print on the label surface of the optical disc media using the remote controller 120.

The system controller 104 displays a search screen on the screen of the television 20 to display an EPG screen including broadcasting date of recording data written to the optical disc media (step S301).

When user inputs search values such as broadcasting date using the remote controller 120, the system controller 104 instructs the processor 108 to download EPG information, and to convert it into process-able data while to supply it to the controller 104. According to the instruction from the system controller 104, the processor 108 downloads EPG data from the EPG service server 60 via the Internet line 50 (step S302). When downloading the EPG information, the processor 108 converts the EPG data into data process-able by the system controller 104, and then, supplies the converted EPG data to the system controller 104.

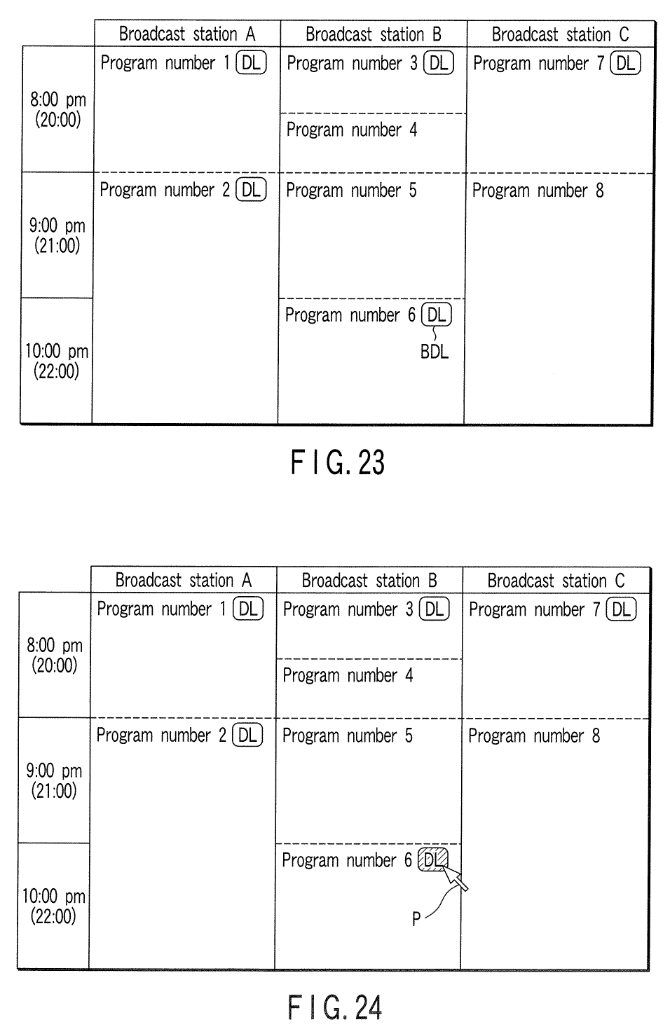

The system controller 104 generates an EPG display signal for displaying it on the television 20 using the supplied EPG data (step S303). The generated EPG display signal is supplied to the television 20, and then, an EPG screen shown in FIG. 23 is displayed on the television 20. In this case, the EPG display signal is supplied to the television 20 through the decoder 111. As seen from FIG. 23, a download button BDL is displayed with respect to a print data downloadable program. The displayed is a past EPG screen; for this reason, no reservation button is displayed.

The system controller 104 is waiting until user presses the Enter button of the remote controller 120 (step S304). The controller 104 recognizes the position of the pointer P in waiting. When user presses the Enter button, the remote controller 120 issues an Enter button operation signal. When receiving the Enter button operation signal, the remote control receiver 106 gives interrupt notification that the Enter button is operated, to the system controller 104 (Yes in step S304).

The system controller 104 determines the position of the pointer P on the EPG screen when the foregoing interrupt notification is given. As a result, if the pointer P is not positioned on a download button (DL button) BDL, the system controller 104 is waiting (No in step S305). As shown in FIG. 24, when user presses the Enter button of the remote controller 120 in a state that the pointer P is positioned on the download button BDL (Yes in step S305), the system controller 104 takes the following procedure. Specifically, the controller 104 instructs the processor 108 to make an access to all addresses of thumbnail image data embedded in EPG information, and to download all thumbnail image data. Then, the processor 108 downloads all thumbnail image data (step S306).

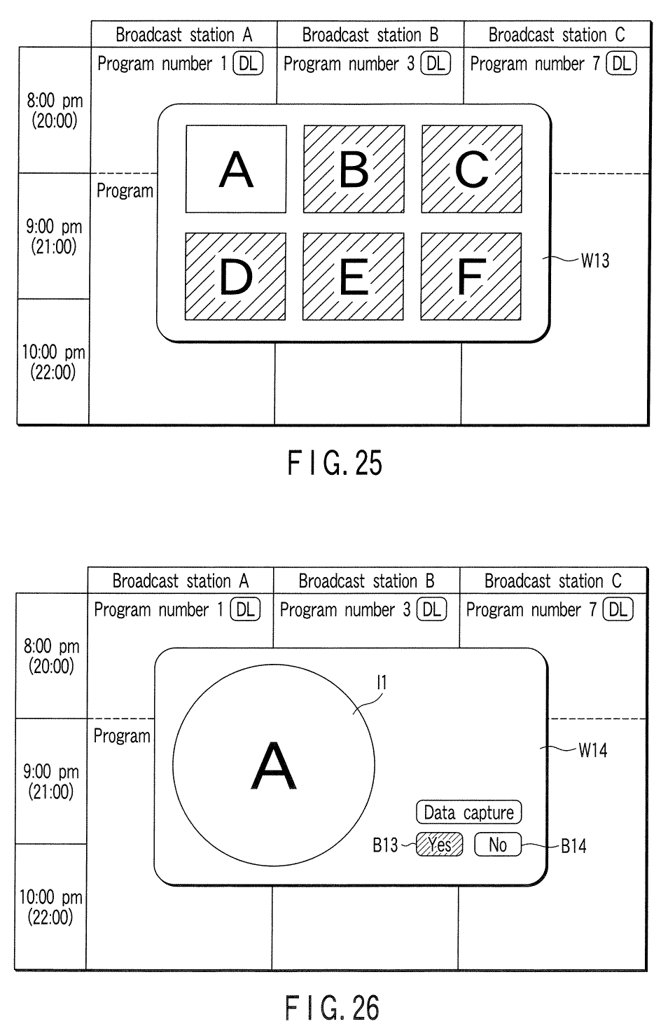

When all thumbnail image data are downloaded, the system controller 104 displays a select window W13 for selecting a download image by user in the EPG screen, as depicted in FIG. 25 (step S307). As seen from FIG. 25, thumbnail images A to F are displayed in the window W13. User operates the remote controller 120 to select any of the thumbnail images A to F thus displayed. The selected thumbnail image is displayed in a state of being highlighted; on the other hand, non-selected thumbnail images are displayed in a state of being darkened.

The system controller 104 is waiting until user presses the Enter button of the remote controller 120 (step S308). When user presses the Enter button, the remote controller 120 issues an Enter button operation signal. When receiving the Enter button operation signal, the remote control receiver 106 gives interrupt notification that the Enter button is operated, to the system controller 104 (Yes in step S308).

When receiving the interrupt notification, the system controller 104 determines the selected thumbnail image (step S309). As shown in FIG. 26, the system controller 104 displays a window W14 for confirming whether or not print data corresponding to the determined thumbnail image may be downloaded, in the EPG screen (step S310). In the window W14, a print image I1 obtained by enlarging and editing the thumbnail image, Yes button B13 and No button B14 are displayed (arranged). User operates the cursor button of the remote controller 120 to select any of Yes button B13 and No button B14. Then, when user presses the Enter button of the remote controller 120, the procedure corresponding to the selected button is taken.

The system controller 104 is waiting until user presses the Enter button of the remote controller 120 (step S311). When user presses the Enter button, the remote controller 120 issues an Enter button operation signal. When receiving the Enter button operation signal, the remote control receiver 106 gives interrupt notification that the Enter button is operated, to the system controller 104 (Yes in step S311). The system controller 104 determines which of Yes button B13 and No button B14 is selected using the Enter button of the remote controller 120. If No button B14 is selected (No in step S312), the system controller 104 again displays the window W13 for selecting a download image by user in the EPG screen (step S307).

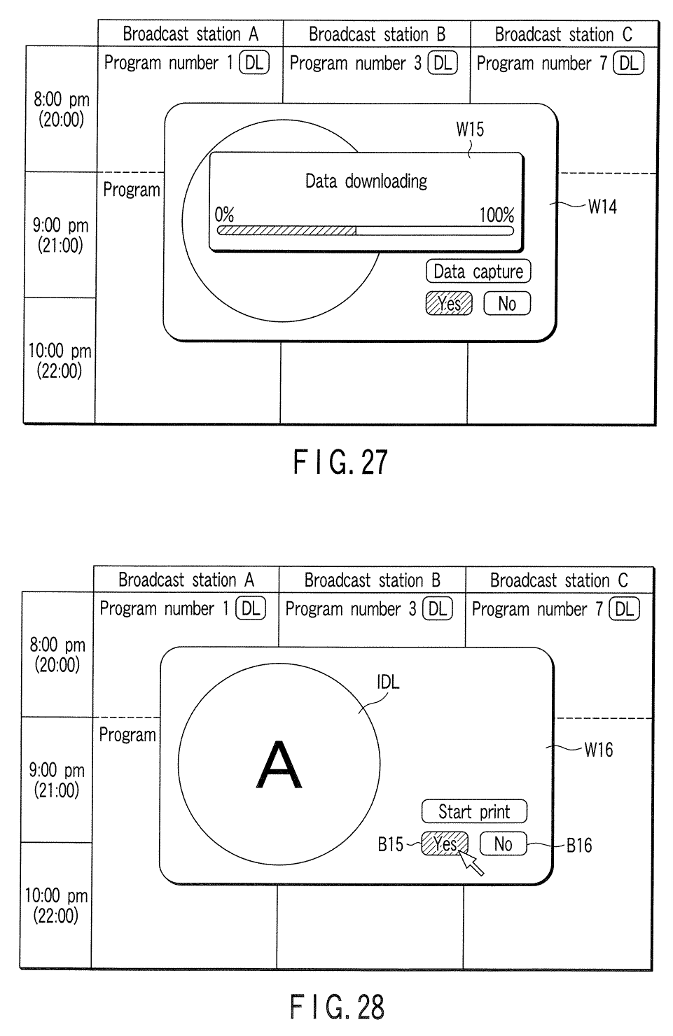

If Yes button B13 is selected (Yes in step S312), the system controller 104 instructs the processor 108 to download print data from the print data server 61. When downloading the print data, the system controller 104 displays a window W15 for informing user of the progress of print data downloading in the screen, as shown in FIG. 27. The print data address is embedded in EPG data. When the print data is downloaded, the system controller 104 stores the print data in the hard disc drive 110 (step S313).

After downloading is completed, the system controller 104 displays a window W16 for confirming whether or not user desires to make print using the downloaded image in the EPG screen, as shown in FIG. 28. In the window W16, an image IDL when print is made on the optical disc media using the downloaded image, Yes button B15 and No button B16 are displayed (arranged). User operates the cursor button of the remote controller 120 to select any of Yes button B15 and No button B16. Then, user presses the Enter button of the remote controller 120, and thereby, the procedure corresponding to the selected button is taken.

The system controller 104 is waiting until user presses the Enter button of the remote controller 120 (step S315). When user presses the Enter button, the remote controller 120 issues an Enter button operation signal. When receiving the Enter button operation signal, the remote control receiver 106 gives interrupt notification that the Enter button is operated, to the system controller 104 (Yes in step S315). The system controller 104 determines which of Yes button B15 and No button B16 is selected using the Enter button of the remote controller 120. If No button B16 is selected (No in step S316), the flow returns to step S307, and then, the system controller 104 again displays the window W13 for selecting a download image.

If Yes button B15 is selected (Yes in step S316), the system controller 104 determines whether or not an optical disc media is inserted in the optical disc drive 109 (step S317). If the optical disc media is not inserted in the optical disc drive 109 (No in step S317), the system controller 104 ejects the tray on which the optical disc media is placed. Thereafter, the controller 104 displays a message of recommending user to an optical disc media on the tray on the screen of the television 20.

The system controller 104 is waiting until the tray of the optical disc drive 109 is closed (step S319). When the tray of the optical disc drive 109 is closed, the optical disc drive 109 gives interrupt notification that the tray is closed, to the system controller 104. If the tray of the optical disc drive 109 is closed (Yes in step S319), the system controller 104 returns to step S317, and then, confirms whether or not an optical disc media is inserted in the optical disc drive 109.

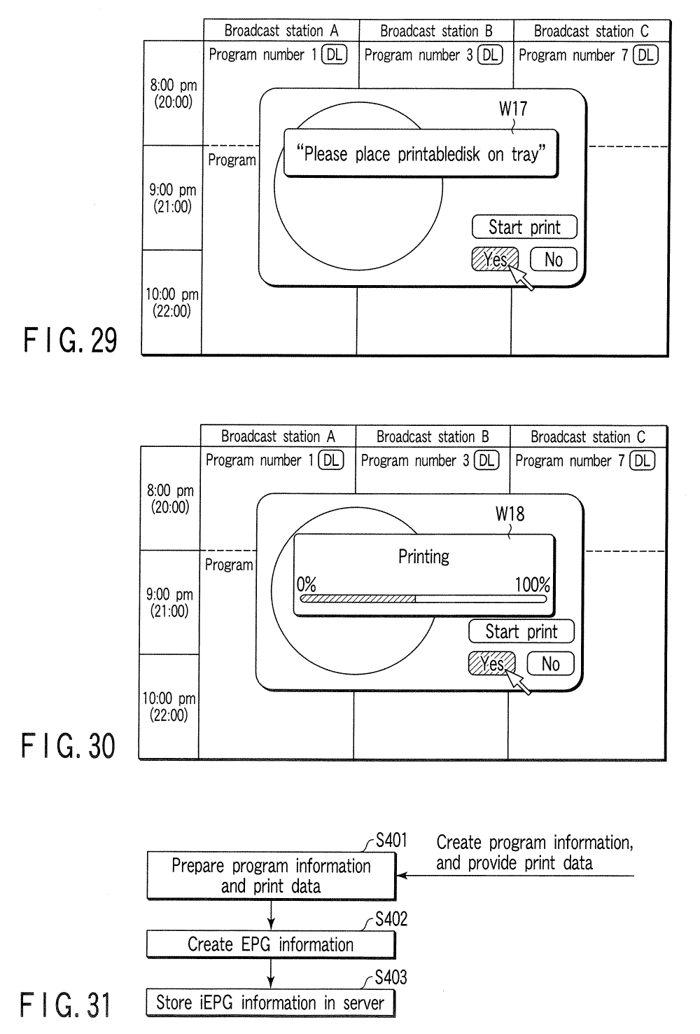

If the optical disc media is inserted in the optical disc drive 109 (Yes in step S317), the system controller 104 determines whether or not a laser radiating section of the optical disc drive 109 is set in a printable state opposite to the label surface of the optical disc media there (step S320). If the laser radiating section is not set in a printable state (No in step S320), the system controller 104 ejects the tray of the optical disc drive 109. Thereafter, the controller 104 displays a message for recommending user to turn over the optical disc media on a window W17 of the television 20 in as shown in FIG. 29 (step S322).

The system controller 104 is waiting until the tray of the optical disc drive 109 is closed (step S323). When the tray of the optical disc drive 109 is closed, the optical disc drive 109 gives interrupt notification that the tray is closed, to the system controller 104 (Yes in step S323). When the tray of the optical disc drive 109 is closed, the system controller 104 returns to step S317. Then, the system controller 104 confirms that the optical disc media is inserted in the optical disc drive 109, and thereafter, confirms whether or not it is printable (step S320).

If the system controller 104 determines that the optical disc media is printable (Yes in step S320), the controller 104 executes the following procedure. Namely, the controller 104 starts the procedure of making print on the label surface of the optical disc media inserted in the optical disc drive 109 using print data saved in the hard disc drive 110 (step S324). During printing, the system controller 104 displays a window W18 for informing user of the progress of printing in the EPG screen, as shown in FIG. 30.

If print onto the label surface of the optical disc media is completed (Yes in step S325), the system controller 104 ejects the tray on which the optical disc media is placed (step S326). In this case, information that print onto the label surface may be completed is displayed on a monitor in place of ejecting the tray.

According to the foregoing embodiment, print is made on the label surface of the optical disc media using the hard disc built-in optical disc recorder 100. In this case, print may be made on the label surface of the optical disc media using the printer 31 connected to the personal computer 30.

According to the embodiment, broadcast programs broadcasted via digital broadcast are recorded, and thereafter, written to the optical disc media. In this case, broadcast programs broadcasted via analog broadcast and CATV broadcast may be recorded, and thereafter, written to the optical disc media.

[5. Procedure of Creating EPG Information]

The method of creating EPG information will be explained below with reference to FIG. 31.

Broadcast stations prepare program information such as program title from broadcast stations, performers and broadcasting time, and address of print data for printing data on the label surface of an optical disc media.

EPG service provider is provided with program information and print data address from broadcast stations, thereby preparing program information and print data (step S401).

The EPG service provider creates EPG information based on program information and print data address provided from broadcast stations (step S402). The EPG information thus created is data prepared according to a predetermined format capable of displaying EPG information on the television 20 by the hard disc built-in optical disc recorder 100.

The prepared EPG information is stored in the EPG service server 60 (step S403). The EPG information is stored in a downloadable address when the hard disc built-in optical disc recorder 100 and the personal computer 30 make an access to the EPG service server 60.

The procedure described above is taken, and thereby, the EPG information is prepared and stored in the EPG service server 60. By doing so, program reservation is made, and print data is downloadable.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of printing on a label surface of an optical disc media, comprising:
acquiring a program guide information including address information for downloading a program information including title and print data printable on a label surface of an optical disc media from a network;
displaying broadcast program guide on a monitor based on the program guide information;
downloading print data corresponding to a broadcast program selected from the broadcast program guide based on the address information; and
printing the downloaded print data on the label surface of the optical disc media.

2. The method according to claim 1, wherein
the program information including broadcasting time information,
the method further comprising,
registering broadcasting time information of the selected broadcast program to make a recording reservation of the broadcast program,
displaying the existence of print data corresponding to the broadcast program making recording reservation,
confirming whether or not user desires to download the print data, and
recording the broadcast program based on the registered broadcasting time information.

3. The method according to claim 1, further comprising,
carrying out the printing after video data corresponding to the selected broadcast program is recorded to a recording surface of the optical disc media,
displaying the existence of the downloaded print data and a print image when print is made using the print data, and
confirming whether or not user desires to carry out print.

4. The method according to claim 1, wherein at least print data of the program guide information is acquired from a server connected to Internet.

5. An optical disc recorder using an optical disc media, comprising:
an information acquiring section acquiring program guide information including address information for downloading program information including title information and print data printable on the label surface of an optical disc media from a network;
a guide display section displaying broadcast program guide on a monitor based on the program guide information;
a download section downloading the print data based on address information corresponding to the broadcast program selected from the broadcast program guide; and
an optical disc drive writing video data corresponding to the broadcast program to a recording surface of the optical disc media, and printing the downloaded print data on a label surface of the optical disc media.

6. The optical disc recorder according to claim 5, wherein
the program information including broadcasting time information,
the optical disc recorder further comprising,
a recording reservation section registering broadcasting time information of the selected broadcast program to make a recording reservation of the broadcast program,
a input section inputting whether or not print data corresponding to the broadcast program making recording reservation is downloadable from a network,
a storage section storing the print data is downloaded, and
a video data generation section recording the broadcast program based on the registered broadcasting time information to generate video data.

7. The optical disc recorder according to claim 6, further comprising,
a hard disc drive storing video data generated by the video data generation section, wherein
the information acquiring section storing the acquired program guide information in the hard disc drive,
the download section storing the downloaded print data in the hard disc drive, and
the optical disc drive writing the video data stored in the hard disc drive to the recording surface of the optical disc media.

8. A method of creating program guide information, comprising:
preparing program information corresponding to a broadcast program, the program information having title information of the broadcast program;
preparing print data corresponding to the broadcast program for printing data on a label surface of an optical disc media;
preparing address information for downloading the print data;
creating program guide information for preparing broadcast program guide, which has the program information and the address information; and
storing the program guide information in a server downloadable via the network by a recorder creating the broadcast program guide and a printer printing data on the label surface of the optical disc media based on the print data.
